(19) United States
(12) Patent Application Publication
(10) Pub. No.: US 2026/0343168 A1
(43) Pub. Date: Oct. 29, 2026

(54) RADAR BASED IN VEHICLE AUDIO COMPENSATION

(71) Applicant: PANASONIC AUTOMOTIVE SYSTEMS AMERICA, LLC., PEACHTREE CITY, GA (US)

(72) Inventors: DANIEL GAVORA, PEACHTREE CITY, GA (US); JAMES LOCK, FAYETTEVILLE, GA (US)

(21) Appl. No.: 19/653,248

(22) Filed: Apr. 21, 2026

Related U.S. Application Data
(60) Provisional application No. 63/793,310, filed on Apr. 23, 2025.

(51) Int. Cl. H04S 7/00; G01S 13/04; H04R 3/12; H04R 5/02; H04R 5/04

(52) U.S. Cl. CPC H04S 7/303; G01S 13/04; H04R 3/12; H04R 5/02; H04R 5/04; H04R 2499/13

(57) ABSTRACT

An audio compensation arrangement is for a motor vehicle having a passenger compartment. At least one sensor detects a position of an occupant of the motor vehicle. An audio system transmits respective audio signals to a plurality of loudspeakers. The loudspeakers each emit sound into the passenger compartment based on a respective one of the audio signals. An electronic processor is communicatively coupled to the at least one sensor and to the audio system. The electronic processor controls tuning settings with which the audio system transmits the respective audio signals to the loudspeakers. The tuning settings are controlled based on the detected position of the occupant.

### CROSS-REFERENCE TO RELATED APPLICATIONS

This application claims benefit of U.S. Provisional Application No. 63/793,310, filed on Apr. 23, 2025, the disclosure of which is hereby incorporated by reference in its entirety for all purposes.

### BACKGROUND OF THE INVENTION

### 1. FIELD OF THE INVENTION

The present invention relates to automatically tuning an audio system in a motor vehicle.

### 2. DESCRIPTION OF THE RELATED ART

Vehicle infotainment systems are precision tuned for specific seating positions and head orientations. For example, if a very tall passenger moves the seat all the way back for legroom, their head is no longer located in the “optimal” tuned location, resulting in a degraded listening experience. The same phenomenon is experienced if a passenger has their head turned to the side to look out the window, rather than facing straight ahead.

Many systems allow selection for listening position priority (e.g., driver only, driver plus passenger, etc.), but require a manual selection of this feature. These settings also do not compensate for head position/orientation.

### SUMMARY OF THE INVENTION

The invention may include one or more radar sensors mounted in the interior of an automobile cabin and used to detect positional data of passengers in the vehicle. This positional data is then used to modify the acoustic output of the infotainment system. For example, tuning settings or parameters may be adjusted based on occupant height and/or head position, the number of occupants, the occupants’ seating positions, etc.

Radar based compensation can eliminate the need to manually toggle audio output based on the locations of passengers. This invention can also automatically turn off audio in unoccupied zones for power saving, which is critical for electric vehicles (EVs).

Camera-based tracking/detection can also be used to ascertain passenger positional data. Seat pressure occupancy sensors can also accomplish zone deactivation.

The invention comprises, in one form thereof, an audio compensation arrangement for a motor vehicle having a passenger compartment. At least one sensor detects a position of one or more occupants of the motor vehicle. An audio system transmits respective audio signals to a plurality of loudspeakers. The loudspeakers each emit sound into the passenger compartment based on a respective one of the audio signals. An electronic processor is communicatively coupled to the at least one sensor and to the audio system. The electronic processor controls tuning settings with which the audio system transmits the respective audio signals to the loudspeakers. The tuning settings are controlled based on the detected position of the occupants.

The invention comprises, in another form thereof, an audio compensation method for a motor vehicle having a passenger compartment, including detecting a position of an occupant of the motor vehicle. Tuning settings of audio signals are controlled based on the detected position of one or more occupants. Respective audio signals are transmitted to a plurality of loudspeakers of the vehicle. Each of the loudspeakers is used to emit sound into the passenger compartment based on a respective one of the audio signals.

The invention comprises, in yet another form thereof, an audio compensation arrangement for a motor vehicle having a passenger compartment and a plurality of loudspeakers. The arrangement includes at least one radar sensor detecting a position of one or more occupants of the motor vehicle. An audio system transmits audio signals to one or multiple groups of loudspeakers that corresponds to the occupant (e.g., the group(s) of loudspeakers that have most influence on what the occupant hears, or that are closest to the occupant’s ears, or that are most focused on the occupant’s ears). The loudspeaker group(s) emits sound into the passenger compartment based on the audio signal. An electronic processor is communicatively coupled to the at least one radar sensor and to the audio system. The electronic processor controls tuning settings with which the audio system transmits the audio signal to the loudspeaker group(s). These tuning settings might be done by adjusting Phase, Volume levels, or even Stereo Positioning of sound from one or multiple drivers. The tuning settings are controlled based on the detected position of the occupant.

The invention may enable better sound quality, enhance private audio, and increase energy conservation.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a radar-based in-vehicle audio compensation arrangement of the present invention.

FIG. 2 is a plan view of a motor vehicle of the present invention including the radar-based in-vehicle audio compensation arrangement of FIG. 1.

FIG. 3 is a side view of a driver of the motor vehicle of FIG. 2 in four different seat positions with four different respective tuning settings.

FIG. 4 is a flow chart of one embodiment of an audio compensation method of the present invention for a motor vehicle having a passenger compartment.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

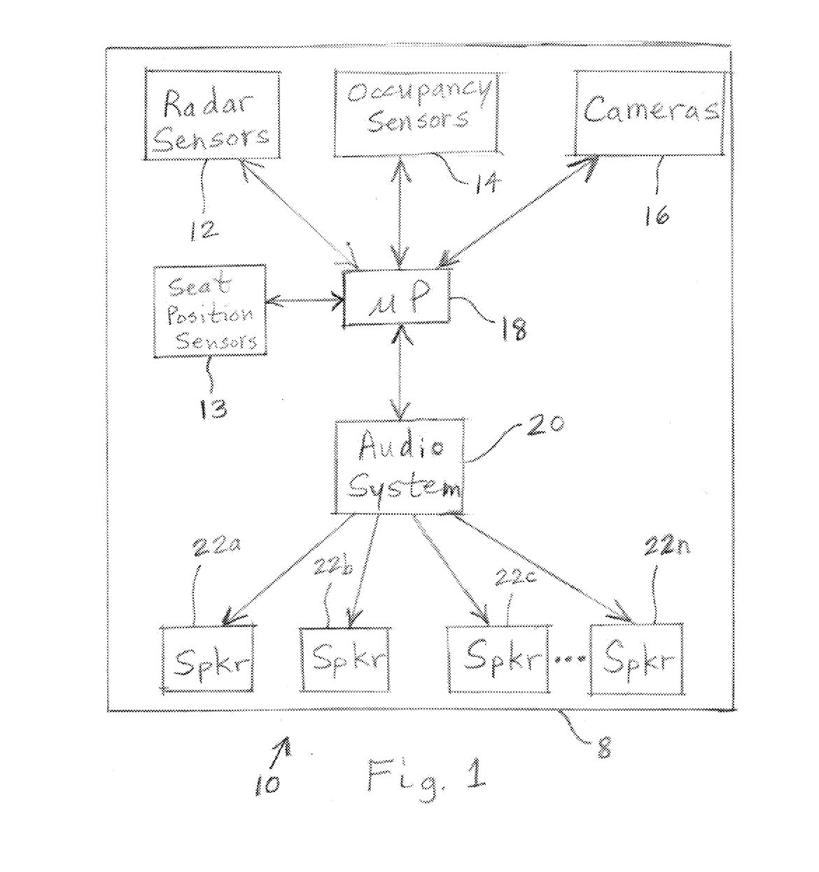

FIG. 1 illustrates one embodiment of a motor vehicle 8 including a radar-based in-vehicle audio compensation arrangement 10 of the present invention having radar sensors 12, seat position sensors 13, seat pressure occupancy sensors 14, cameras 16, an electronic processor 18, an infotainment audio system 20, and loudspeakers 22a-n. Loudspeakers 22a-n include door speakers 22a-d, headrest speakers 22e-l, a center channel speaker 22m and a subwoofer 22n.

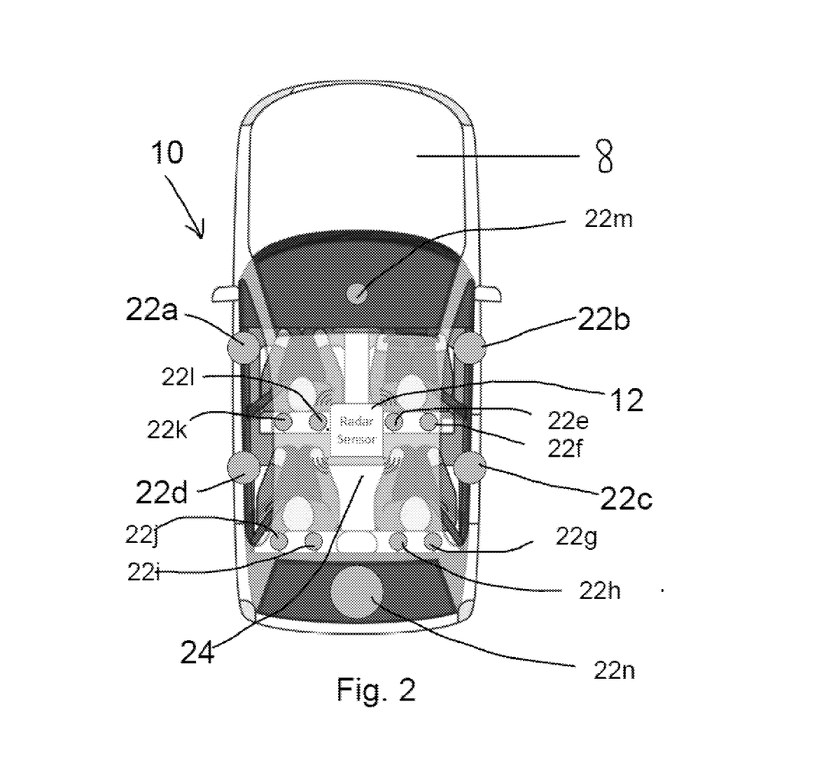

As shown in FIG. 2, each door loudspeaker 22a-d is adjacent a respective one of the four seats of vehicle 8, and each headrest speakers 22e-l is above a corresponding one of the four seats of vehicle 8. Center channel speaker 22m and subwoofer 22n may serve all four of the seats substantially equally.

Each loudspeaker 22a-d may be most prominently heard by a human occupant of the adjacent seat, if there is an occupant. Similarly, each headrest speaker 22e-l may be most prominently heard by a human occupant of the corresponding seat. Speaker configurations vary depending on vehicle type and model level (e.g., Base vs Premium Audio).

Loudspeakers 22a-n may be divided into “groups” as they are referred to herein. For example, speakers 22b, 22e and 22f may be a group that is characterized as the speakers that are closest to the ears of the front seat passenger. Speakers 22a, 22b, 22e and 22f may be a group that is characterized as the speakers that most influence what is heard by the front seat passenger or how he perceives his listening experience. Speakers 22e and 22f may be a group that is characterized as the speakers that are most focused on the ears of the front seat passenger. These groups are just examples, and are not meant to convey any limitations on the number of speakers that can be in a group or how a group may be characterized.

Radar sensors 12 may be mounted on a central area of the bottom surface of roof 24. Each radar sensor 12 may detect the head position of an occupant of a respective seat, as indicated in FIG. 2.

Seat position sensors 13 may detect the position of each seat in the forward and rearward directions, as well as the degree of tilt of the back of the seat that is typically engaged by the back of the occupant. Occupancy sensors 14 may detect the amount of weight on each seat, and it may be determined therefrom whether each seat is likely occupied by a human occupant.

Cameras 16 may be located at any position in which they can capture images indicative of the heads of the passengers of vehicle 8. Cameras 16 may also be able to determine the directions in which the passengers’ heads are turned and/or tilted. Camera head-tracking may include image processing techniques such as facial landmark detection, or convolutional neural network (CNN)-based pose estimation, for example.

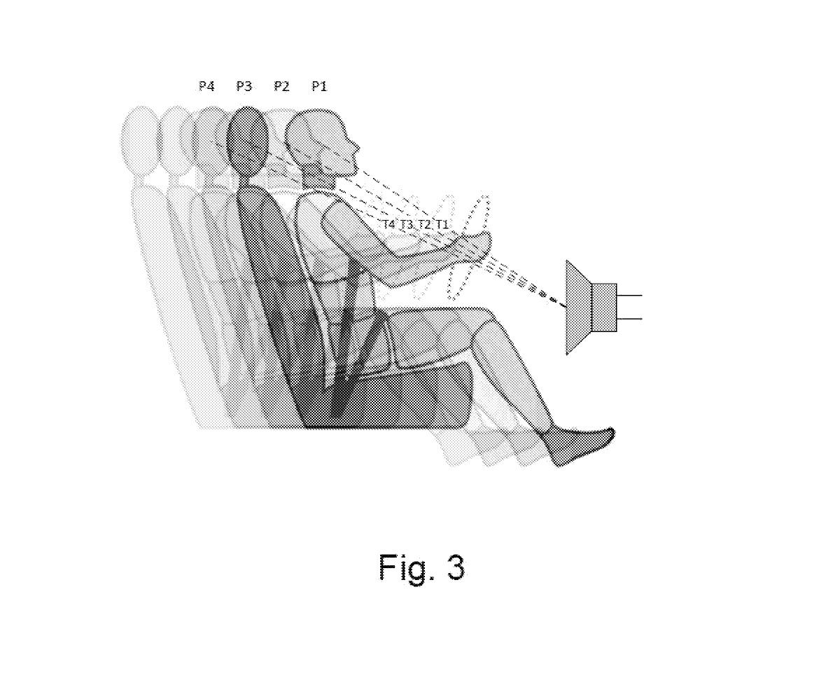

As shown in the specific example of FIG. 3, the human occupant may have four possible head positions P1, P2, P3, P4 in the forward and rearward directions. Which of these positions the occupant’s head is currently in may be determined from readings from one or more of radar sensors 12, seat position sensors 13, occupancy sensors 14 and cameras 16. Depending on the determined head position, audio system 20 may provide an optimal one of tuning settings T1, T2, T3, T4 to be played on loudspeakers 22a-22d. Typically, the tuning setting of the audio played on a certain loudspeaker is influenced by the position of the head relative to all loudspeakers (e.g., time alignment and phase). Processor 18 may access from memory stored tuning profiles indexed to detected head position zones. This operation may be discrete (e.g., zone-based) or continuous (e.g., interpolated between stored profiles). The mapping may be made via a lookup table, an interpolation method, a stored profile structure, and/or a decision algorithm, for example.

The tuning settings can include any conventional tuning settings that are made in automobiles or other places. The tuning settings can include, for example, equalizer settings, such as bass, midrange and treble. Other possible tuning settings are balance and fade; crossover settings; dynamic range compression; surround sound settings; loudness control; room correction or calibration; subwoofer tuning; and DSP (Digital Signal Processing) modes.

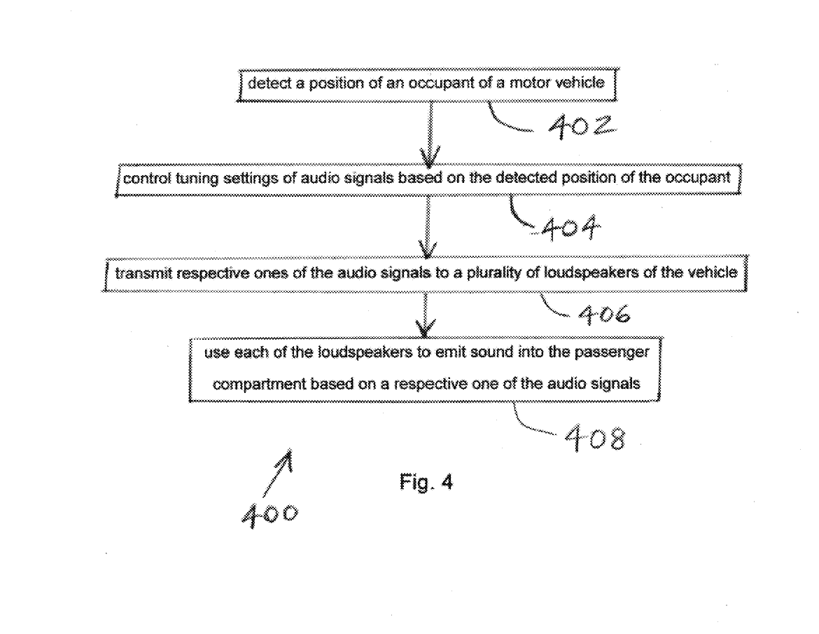

FIG. 4 illustrates one embodiment of an audio compensation method 400 of the present invention for a motor vehicle having a passenger compartment. In a first step 402, a position of an occupant of the motor vehicle is detected. For example, radar sensors 12, seat position sensors 13, occupancy sensors 14 and/or cameras 16 may detect a position of an occupant of a motor vehicle.

Next, in step 404, tuning settings of audio signals are controlled based on the detected position of the occupant. For example, depending on the determined position of the occupant, audio system 20 may provide optimal tuning settings for audio signals to be played on loudspeakers 22a-22d. The tuning settings can include, for example, equalizer settings, such as bass, midrange and treble; balance and fade; crossover settings; dynamic range compression; surround sound settings; loudness control; room correction or calibration; subwoofer tuning; and DSP (Digital Signal Processing) modes.

In a next step 406, respective audio signals are transmitted to a plurality of loudspeakers of the vehicle. For example, audio system 20 may transmit audio signals including the tuning settings to loudspeakers 22a-22n.

In a final step 408, each of the loudspeakers is used to emit sound into the passenger compartment based on a respective one of the audio signals. For example, each of the loudspeakers 22a-22n may emit sound into the passenger compartment of vehicle 8 based on a respective one of the audio signals transmitted by audio system 20.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An audio compensation arrangement for a motor vehicle having a passenger compartment, the arrangement comprising:
at least one sensor configured to detect a position of an occupant of the motor vehicle;
an audio system configured to transmit respective audio signals to a plurality of loudspeakers, the loudspeakers each emitting sound into the passenger compartment based on a respective one of the audio signals; and
an electronic processor communicatively coupled to the at least one sensor and to the audio system, the electronic processor being configured to control tuning settings with which the audio system transmits the respective audio signals to the loudspeakers, the tuning settings being controlled based on the detected position of the occupant.

2. The arrangement of claim 1 wherein the at least one sensor includes at least one of a radar sensor, a seat position sensor, a seat pressure occupancy sensor, and a camera.

3. The arrangement of claim 1 wherein the tuning settings include at least one of: equalizer settings; balance and fade; crossover settings; dynamic range compression; surround sound settings; loudness control; room correction/calibration; subwoofer tuning settings; and DSP (Digital Signal Processing) modes.

4. The arrangement of claim 1 wherein the at least one sensor is configured to detect a position and orientation of a head of the occupant of the motor vehicle.

5. The arrangement of claim 1 wherein the at least one sensor is configured to detect a position of a head of the occupant of the motor vehicle in forward and rearward directions.

6. The arrangement of claim 1 wherein the tuning settings are controlled based on the detected position of the occupant relative to a position of a group of loudspeakers.

7. The arrangement of claim 1 wherein the at least one sensor is configured to detect an orientation of a head of the occupant of the motor vehicle in a tilt direction and in a rotational direction about a vertical axis.

8. An audio compensation method for a motor vehicle having a passenger compartment, the method comprising:
detecting a position of an occupant of the motor vehicle;
controlling tuning settings of audio signals based on the detected position of the occupant;
transmitting respective said audio signals to a plurality of loudspeakers of the vehicle; and
using each of the loudspeakers to emit sound into the passenger compartment based on a respective one of the audio signals.

9. The method of claim 8 wherein the detecting step is performed by at least one of a radar sensor, a seat position sensor, a seat pressure occupancy sensor, and a camera.

10. The method of claim 8 wherein the tuning settings include at least one of: equalizer settings; balance and fade; crossover settings; dynamic range compression; surround sound settings; loudness control; room correction/calibration; subwoofer tuning settings; and DSP (Digital Signal Processing) modes.

11. The method of claim 8 wherein the detecting step includes detecting a position and orientation of a head of the occupant of the motor vehicle.

12. The method of claim 8 wherein the detecting step includes detecting a position of a head of the occupant of the motor vehicle in forward and rearward directions.

13. The method of claim 8 wherein the tuning settings are controlled based on the detected position of the occupant relative to a position of a group of loudspeakers that contributes most to what the occupant hears.

14. The method of claim 8 wherein the detecting step includes detecting an orientation of a head of the occupant of the motor vehicle in a tilt direction and in a rotational direction about a vertical axis.

15. An audio compensation arrangement for a motor vehicle having a passenger compartment and a plurality of loudspeakers, the arrangement comprising:
at least one radar sensor configured to detect a position of an occupant of the motor vehicle;
an audio system configured to transmit a plurality of audio signals to a group of loudspeakers corresponding to the occupant, the corresponding group of loudspeakers emitting sound into the passenger compartment based on the audio signals; and
an electronic processor communicatively coupled to the at least one radar sensor and to the audio system, the electronic processor being configured to control tuning settings with which the audio system transmits the audio signals to the corresponding group of loudspeakers, the tuning settings being controlled based on the detected position of the occupant.

16. The arrangement of claim 15 wherein the audio system is configured to inhibit transmission of audio signals to a loudspeaker corresponding to a space within the passenger compartment that the at least one radar sensor has detected is unoccupied by any occupant.

17. The arrangement of claim 15 wherein the tuning settings include at least one of: equalizer settings; balance and fade; crossover settings; dynamic range compression; surround sound settings; loudness control; room correction/calibration; subwoofer tuning settings; and DSP (Digital Signal Processing) modes.

18. The arrangement of claim 15 wherein the at least one radar sensor is configured to detect a position and orientation of a head of the occupant of the motor vehicle.

19. The arrangement of claim 15 wherein the at least one sensor is configured to detect a position of a head of the occupant of the motor vehicle in forward and rearward directions.

20. The arrangement of claim 15 wherein the tuning settings are controlled based on the detected position of the occupant relative to a position of the corresponding group of loudspeakers that is closest to the occupant.
